(19) United States
(12) Patent Application Publication
(10) Pub. No.: US 2025/0178916 A1
(43) Pub. Date: Jun. 5, 2025

(54) PRODUCTION OF LITHIUM OXIDE POWDERS

(71) Applicant: Albemarle Corporation, Charlotte, NC (US)

(72) Inventors: Mohammad NOROUZI BANIS, Lawrenceville, GA (US); Yinzhi ZHANG, Charlotte, NC (US); Job T. RIJSSENBEEK, Lake Wylie, SC (US)

(73) Assignee: Albemarle Corporation, Charlotte, NC (US)

(21) Appl. No.: 18/842,926

(22) PCT Filed: Feb. 16, 2023
(86) PCT No.: PCT/US2023/013215

§ 371 Date: Aug. 30, 2024

Related U.S. Application Data
(60) Provisional application No. 63/316,206, filed on Mar. 3, 2022.

(51) Int. Cl. C01D 15/02

(52) U.S. Cl. CPC C01D 15/02; C01P 2002/72; C01P 2006/80

(57) ABSTRACT

This invention provides processes for preparing lithium oxide powders from combinations of lithium salts.

### TECHNICAL FIELD

This invention relates to processes for preparing lithium oxide powders.

### BACKGROUND

Lithium oxide is used in lithium batteries, glass and ceramics, as well as in other applications. In some applications, the presence of lithium hydroxide and/or other lithium compounds as impurities in lithium oxide is not desirable.

Many methods for producing lithium oxide are known, but most have one or more disadvantages in terms of process conditions, product purity, and/or economic feasibility. Processes that do not require harsh conditions or a large number of steps, produce relatively pure lithium oxide, and are economically feasible are desired.

### SUMMARY OF THE INVENTION

This invention provides lithium oxide powders containing a lithium salt. Some of these lithium oxide powders may be slightly stable in ambient air if the lithium salt is coated on the lithium oxide. This invention also provides high purity lithium oxide powders that contain a minimal amount of lithium salt and which are not ambient air stable.

An embodiment of this invention is a process for producing a powder comprising lithium oxide and a lithium salt. The process comprises heating a mixture of two lithium salts at one or more temperatures ranging from about 50 degrees Celsius below the eutectic point of the mixture of two different lithium salts to a temperature below the melting point of the lithium salt having a lower melting point, to form a powder comprising lithium oxide and a lithium salt. During the process, at least a portion of gaseous byproducts produced by the process is removed. Optionally, a non-reactive additive is present in the mixture of two lithium salts.

Another embodiment of this invention is a process for converting the lithium salt that is present in a powder comprising lithium oxide and a lithium salt into lithium oxide. This process can also be viewed as a process for purifying a powder comprising lithium oxide and a lithium salt by converting the lithium salt that is present into lithium oxide. The process comprises heating the powder comprising lithium oxide and a lithium salt at one or more temperatures in the range of about 25 degrees Celsius below the melting point of the lithium salt to a temperature about 200 degrees Celsius above the melting point of the lithium salt.

Other embodiments of the invention include powders comprising lithium oxide and a lithium salt.

These and other embodiments and features of this invention will be still further apparent from the ensuing description and appended claims.

### BRIEF DESCRIPTION OF THE DRAWINGS

FIG. 1 contains photographic images of the products of a heating step for lithium salts using different reaction parameters.

FIG. 2 has two x-ray powder diffraction patterns for products formed according to processes of the invention; one for a powder comprising lithium oxide and lithium carbonate, and one for lithium oxide not containing lithium carbonate.

FIG. 3 is an x-ray powder diffraction pattern for a powder comprising lithium oxide and lithium carbonate formed according to a process of the invention.

FIG. 4 is an x-ray powder diffraction pattern for a product formed by heating lithium hydroxide monohydrate and lithium carbonate in the absence of a non-reactive additive.

The figures illustrate embodiments of specific aspects of the invention, and are not intended to impose limitations on the scope of the invention.

### FURTHER DETAILED DESCRIPTION OF THE INVENTION

As used throughout this document, the phrase “lithium salt” includes lithium hydroxide, which is normally considered to be a base rather than a salt.

In the process for producing a powder comprising lithium oxide (Li₂O) and a lithium salt, one of the two lithium salts has a higher melting point and the other lithium salt has a lower melting point. The lithium salt with the higher melting point is sometimes referred to as the higher-melting lithium salt or the higher-melting salt. The other lithium salt is sometimes referred to as the lower-melting lithium salt or lower-melting salt. In this document, when specific combinations of lithium salts are mentioned, the lower-melting salt is usually listed first.

Normally, both of the lithium salts used in a process of the invention are capable of forming lithium oxide when heated under subatmospheric (reduced) pressure and/or in the presence of an inert gas flow or oxygen-containing inert gas flow.

Preferred combinations of two lithium salts in the practice of this invention include lithium nitrate and lithium bromide; lithium hydroxide and lithium bromide; lithium bromide and lithium carbonate; lithium hydroxide and lithium carbonate; lithium bromide and lithium chloride; and lithium nitrate and lithium bromide. A preferred combination of lithium salts is lithium hydroxide and lithium carbonate.

In lithium salt combinations which include lithium hydroxide, the lithium hydroxide can be anhydrous lithium hydroxide or lithium hydroxide monohydrate; lithium hydroxide monohydrate is preferred. Anhydrous lithium hydroxide is preferably handled under an inert gas (i.e., not containing moisture, CO₂, or other species that may react with lithium hydroxide); the inert gas preferably comprises one or more inert gases, typically one or more of helium, nitrogen, and argon.

When the two lithium salts are lithium hydroxide and lithium carbonate, the lithium carbonate may be introduced to the lithium hydroxide by adding solid lithium carbonate or by forming lithium carbonate in situ. Lithium carbonate can be formed in situ by reacting some of the lithium hydroxide with carbon dioxide by passing carbon dioxide gas over the lithium hydroxide, which can be accomplished in about 5 minutes at about 50° C. on the laboratory scale, or by contacting the lithium hydroxide and ambient atmosphere (air), optionally with heating, e.g., at about 50° C. for about 3 hours on the laboratory scale. Another way is to allow the lithium hydroxide to be in contact with air for several minutes while reducing the particle size of the lithium hydroxide; when this is done, the lithium carbonate usually forms a coating on the lithium hydroxide.

For the higher-melting lithium salt, the minimum amount has not been optimized, but may be about 0.1 wt % or more relative to the total weight of the mixture of the low-melting lithium salt and high-melting lithium salt, typically about 0.1 wt % to about 20 wt %, preferably about 0.1 wt % to about 15 wt %, more preferably about 0.2 wt % to about 15 wt %, even more preferably about 0.3 wt % to about 12 wt %, relative to the total weight of the mixture. When a non-reactive additive is present, these amounts refer to the total weight of the mixture including the non-reactive additive.

When the higher-melting salt is lithium carbonate, typical amounts are about 0.1 wt % or more, preferably about 0.2 wt % or more, and generally are in the range of about 0.1 wt % to about 15 wt %, preferably about 0.1 wt % to about 12 wt %, more preferably about 0.2 to about 12 wt %, relative to the total weight of the mixture. It has been observed that as the amount of lithium carbonate increases, the temperature can be decreased (e.g., 410° C. for 5 wt % lithium carbonate), while lower amounts of lithium carbonate generally need higher temperatures (e.g., 420° C. for 1 wt % lithium carbonate).

One or both of the two lithium salts can be reduced to a desired average particle size prior to contact with the other lithium salt and, when used, a non-reactive additive. Preferably, the average particle sizes of the two lithium salts are selected to maximize contact between the particles of the two lithium salts, and the lower-melting lithium salt preferably has a larger average particle size than the average particle size of the higher-melting lithium salt. The lower-melting lithium salt preferably has average particle sizes in the range of about 5 μm to about 700 μm, more preferably about 10 μm to about 600 μm, even more preferably about 15 μm to about 500 μm, and the higher-melting lithium salt preferably has average particle sizes in the range of about 2.5 μm to about 75 μm, more preferably about 5 μm to about 65 μm, even more preferably about 10 μm to about 45 μm. Particle size reduction, when performed, can be accomplished by conventional techniques.

The optional non-reactive additive is a substance that melts above the melting point of the higher-melting lithium salt and does not react with either lithium salt of the pair of lithium salts, or with lithium oxide. The non-reactive additive minimizes or prevents agglomeration of the lithium oxide formed during the process, and permits the process to be conducted at slightly higher temperatures. In some embodiments, presence of a non-reactive additive is preferred.

Suitable non-reactive additives include lithium oxide, quartz, and inorganic oxide beads such as silica beads or zirconia beads. The non-reactive additive is preferably lithium oxide. Mixtures of any two or more non-reactive additives may be used. When the non-reactive additive is lithium oxide, there is no need for a purification step to remove the non-reactive additive at the end of the process. When the higher-melting salt is lithium carbonate, the non-reactive additive is preferably a substance that melts at about 725° C. or above.

When present, the non-reactive additive is generally in an amount of about 1 wt % or more relative to the total weight of the mixture, although this has not been optimized. Generally, the amount of the non-reactive additive is in the range of about 1 wt % to about 90 wt %. In some embodiments, the amount of the non-reactive additive is in the range of about 20 wt % to about 90 wt %, preferably in the range of about 25 wt % to about 85 wt %, more preferably in the range of about 50 wt % to about 80 wt %, relative to the total weight of the mixture. In other embodiments, the amount of the non-reactive additive is in the range of about 1 wt % to about 20 wt %, preferably in the range of about 3 wt % to about 17 wt %, more preferably in the range of about 5 wt % to about 15 wt %, relative to the total weight of the mixture.

For the non-reactive additive, the average particle size is preferably in the range of about 5 μm to about 700 μm, more preferably about 10 μm to about 600 μm, even more preferably about 15 μm to about 500 μm. In some embodiments, the average particle size of the non-reactive additive is preferably similar to or smaller than the average particle size of the lower-melting lithium salt. Particle size reduction, when performed, can be accomplished by conventional techniques.

For the two lithium salts and optional non-reactive additive, the weight percents are determined from the amounts of materials as weighed, e.g., on a balance or scale. In some instances, for example when the two lithium salts are lithium hydroxide and lithium carbonate, and lithium carbonate is generated in situ, the amount of lithium carbonate is determined by x-ray powder diffraction (XRD), with the understanding that there may be some amount of error in the XRD determinations because XRD detects only crystalline phases.

The order of addition or mixing of the high-melting lithium salt, low-melting lithium salt, and optional non-reactive additive has not been observed to affect the process or the results obtained. It is preferred to combine the low-melting lithium salt and the high-melting lithium first, especially when the high-melting salt is lithium carbonate formed in situ, and then introduce a non-reactive additive when used.

To mix the high-melting lithium salt, low-melting lithium salt, and optional non-reactive additive any conventional method or apparatus for mixing solids can be employed, such as an acoustic mixer, a ball mill (with a flow of a gas, for example, air, inert gas, or CO₂), or a jet mill. Liquid methods for mixing the two lithium salts and/or non-reactive additive (when used) can be used when at least two of these components are soluble in the selected medium; such liquid methods include spray drying of a solution, suspension, or slurry of the components, a sol-gel process, or co-precipitation of the components from a liquid.

Heating of the two lithium salts while removing at least a portion of gaseous byproducts produced by the process usually causes the lower-melting lithium salt to form lithium oxide. The reaction zone is a location where the heating of the two lithium salts (with or without a non-reactive additive) occurs. Typically, a reaction zone may be an oven (e.g., a stationary oven), a kiln such as a rotary kiln or a roller hearth kiln, a furnace such as a vertical furnace or tube furnace, or a fluidized bed; a fluidized bed is sometimes preferred.

Heating can include any convenient method that reaches and maintains the desired reaction temperature(s). Suitable types of heating include thermal heating, microwave heating, and optical heating (e.g., with a xenon arc lamp); two or more types of heating can be used. Thermal heating is often preferred.

The heating can be conducted in batch or continuous mode. Continuous mode operations can be conducted for example by feeding a series of reaction vessels through a reaction zone. Rotary kilns and roller hearth kilns are operable in a continuous mode by introducing the two lithium salts at an inlet and operating the kiln so that the two lithium salts move through the kiln and exit the outlets in a continuous manner. Fluidized beds are also operable in a continuous mode.

Once the mixture is formed, heating of the mixture may commence. In some embodiments, the reaction zone may already be at the desired reaction temperature. In embodiments in which the reaction zone is at a temperature lower than the desired reaction temperature, heating of the mixture to the desired reaction temperature is preferably at a rate of about 3° C./min. to about 100° C./min., preferably at a rate of about 5° C./min. to about 50° C./min., more preferably at a rate of about 8° C./min. to about 50° C./min.; these heating rates have not been optimized. When using a temperature gradient or a temperature profile, optimizing the heating rate is recommended and preferred to obtain the product with minimal agglomeration.

In the processes of the invention, formation of lithium oxide from two lithium salts is accompanied by formation of gaseous byproducts (e.g., carbon dioxide and water). Removing gaseous byproducts shifts the reaction equilibrium to the product (lithium oxide) and minimizes or prevents re-formation of the starting materials (the two lithium salts). Removal of gaseous byproducts typically increases the reaction speed. The removing of gaseous byproducts is typically accomplished by conducting the process under reduced (subatmospheric) pressure or in the presence of a flow of an inert gas or an oxygen-containing inert gas.

The inert gas when used alone or as part of an oxygen-containing inert gas preferably comprises one or more inert gases, typically one or more of helium, nitrogen, and argon. The oxygen-containing inert gas can have any amount of oxygen; an atmospheric amount, e.g., about 21% oxygen, is convenient, but greater or lesser amounts of oxygen can be present in the oxygen-containing inert gas, and are not expected to negatively affect the reaction. The inert gas and the oxygen-containing inert gas preferably contain only small or adventitious amounts of water and/or carbon dioxide, more preferably about 1000 ppm or less of water and about 500 ppm or less of carbon dioxide.

When the heating of the two lithium salts (with or without the presence of a non-reactive additive) is conducted in the presence of a flow of an inert gas or an oxygen-containing inert gas, the flow rate is sufficient to remove enough gaseous byproducts to keep the reaction equilibrium favoring the products varies with the heating device, reaction temperatures, and the two lithium salts present in the reaction mixture. Flow rates for the inert gas or oxygen-containing inert gas are preferably in the range of about 40 sccm to about 10,000 sccm, more preferably about 500 sccm to about 7500 sccm, even more preferably about 1000 sccm to about 6000 sccm.

When the heating of the two lithium salts (with or without the presence of a non-reactive additive) is conducted under reduced pressure, the pressure is preferably about 608 torr (81 kPa) or less, more preferably about 380 torr (51 kPa) or less, still more preferably about 230 torr (31 kPa) or less, even more preferably about 20 torr (2.7 kPa) or less. Optionally, an inert gas or oxygen-containing inert gas can be fed to the reaction zone while maintaining a reduced pressure.

When the desired temperature is reached, the mixture can be heated at that temperature for the length of time necessary to form lithium oxide from one of the lithium salts, or the temperature can be changed during the reaction as desired. The temperature can be increased to increase the conversion rate as lithium oxide is formed during the process. The time is affected by the reaction temperature as well as the type of reaction zone. For example, in a stationary oven the reaction may take about 20 hours to be complete, while in a rotary kiln, the same reaction may take about 3 hours or less to be complete.

In these processes, in localized spots, particularly along interfaces between the two lithium salts, the two lithium salts may be present in amounts that constitute a eutectic mixture. The temperature for the process ranges from about 50 degrees Celsius below the eutectic point of the two lithium salts to below the melting point of the lithium salt having the lower melting point. Preferably, the heating is at one or more temperatures ranging from about 20 degrees Celsius below the eutectic point of the mixture of two different lithium salts to a temperature below the melting point of the lithium salt having a lower melting point. It is possible that the lower temperature for this process can be a temperature even farther below the eutectic point of the two lithium salts, but this parameter has not been optimized. Extensive melting of the lower-melting lithium salt is not desired, and tends to produce agglomerated powders, or a solid that adheres to the reaction vessel, so temperatures a few degrees below the melting point of the lower-melting lithium salt are preferred. Melting of the lower-melting lithium salt also causes corrosion of the reaction vessel, which introduces impurities into the product.

When the two lithium salts are lithium nitrate and lithium bromide, the temperature is preferably in the range of about 178° C. to below about 255° C., more preferably in the range of about 178° C. to about 250° C. When the two lithium salts are lithium hydroxide and lithium bromide, the temperature is preferably in the range of about 225° C. to below about 470° C., more preferably about 225° C. to about 465° C. When the two lithium salts are lithium bromide and lithium carbonate, the temperature is preferably in the range of about 446° C. to below about 550° C., more preferably about 446° C. to about 545° C. When the two lithium salts are lithium bromide and lithium chloride, the temperature is preferably in the range of about 471° C. to below about 550° C., more preferably in the range of about 471° C. to below about 545° C.

In more preferred embodiments in which the two lithium salts are lithium nitrate and lithium bromide, the temperature is preferably in the range of about 208° C. to below about 255° C., more preferably in the range of about 208° C. to about 250° C. In more preferred embodiments in which the two lithium salts are lithium hydroxide and lithium bromide, the temperature is preferably in the range of about 255° C. to below about 470° C., more preferably about 255° C. to about 465° C. In more preferred embodiments in which the two lithium salts are lithium bromide and lithium carbonate, the temperature is preferably in the range of about 476° C. to below about 550° C., more preferably about 476° C. to about 545° C. In more preferred embodiments in which the two lithium salts are lithium bromide and lithium chloride, the temperature is preferably in the range of about 501° C. to below about 550° C., more preferably in the range of about 501° C. to below about 545° C.

When the two lithium salts are lithium hydroxide and lithium carbonate, the temperature is preferably in the range of about 380° C. to below about 470° C., more preferably in the range of about 380° C. to about 460° C. In some embodiments, the temperature is preferably in the range of about 380° C. to about 425° C. In some embodiments, the temperature is varied during the process. In preferred embodiments in which the temperature is varied, it is slowly raised during the process from about 380° C. to about 460° C.

In more preferred embodiments in which the two lithium salts are lithium hydroxide and lithium carbonate, the temperature is preferably in the range of about 410° C. to below about 470° C., more preferably in the range of about 410° C. to about 460° C. In some more preferred embodiments, the temperature is preferably in the range of about 410° C. to about 425° C. In some embodiments, the temperature is varied during the process. In some more preferred embodiments in which the temperature is varied, it is slowly raised during the process from about 410° C. to about 460° C.

It has been observed that particle size affects the reaction time and temperature needed to complete conversion to lithium oxide, with longer reaction times needed for larger particles, at least when the two lithium salts are lithium hydroxide and lithium carbonate.

It has been observed that particle size and morphology do not appear to be significantly altered by the processes of this invention. The particles change chemically from two lithium salts to lithium oxide and one lithium salt, with the lithium salt presumably forming a coating on the particles. The particles of the product are often less dense than the particles of the starting materials.

The product of heating the two lithium salts and optionally a non-reactive additive is a powder comprising lithium oxide and one of the lithium salts, normally the higher-melting lithium salt, and the product is usually a free-flowing powder. Some of these powders comprising lithium oxide and one of the lithium salts may be slightly stable in ambient air if the lithium salt is coated on the lithium oxide.

The amount of lithium salt present in the powder comprising lithium oxide and a lithium salt can be any of various amounts, from slightly less than the amount present at the beginning of the process to about 0.1 wt %, depending on the speed of the reaction, and length of time in the reaction zone. Generally, the amount of lithium salt present in the powder comprising lithium oxide and a lithium salt is about 10 wt % or less, often about 5 wt % or less, and frequently about 3 wt % or less.

Optionally, the powder comprising lithium oxide and a lithium salt can be subjected to one or more particle size reduction techniques. Particle size reduction usually makes the product air-sensitive, so it is recommended and preferred to perform the particle size reduction under an inert gas or oxygen-containing inert gas having the features described above.

An advantage of the processes of this invention for forming a powder comprising lithium oxide and a lithium salt is that bulk melting does not occur during the process, which normally prevents introduction of impurities from the reaction vessel. The process is not a solution process or a melting process, and may be a solid-state reaction or semi-solid state reaction. Small amounts of localized melting may occur during the process, but not to an extent that causes observable corrosion of the reaction vessel or introduction of detectable amounts of impurities.

Another advantage of the processes of this invention is that the product is obtained in powder form, which provides benefits. One of the benefits is that the products of the processes do not adhere to the walls of the reaction vessel, allowing for easier collection of the product.

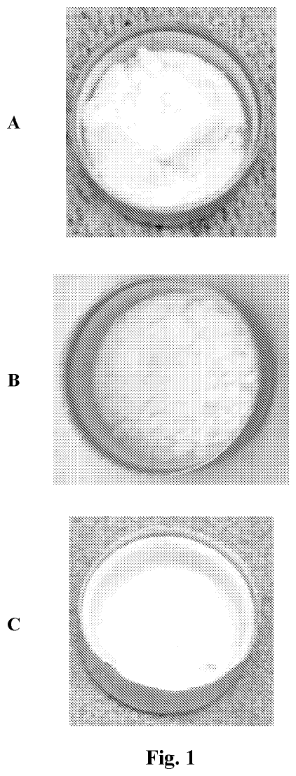

FIG. 1 shows products of various processes of heating lithium hydroxide. FIG. 1A shows a product of a process according the present invention, which product is a free-flowing powder. FIG. 1B shows a product of a process in which no non-reactive additive was present, which product is an agglomerated powder. FIG. 1C shows a product of a process in which lithium hydroxide was heated without any other ingredients added; the product appears to have melted extensively.

The relative amounts of lithium oxide and the lithium salt in the product powder comprising lithium oxide and a lithium salt depend to some extent on the amounts of the two lithium salts present in the mixture at the beginning of the process. In the product powder, the lithium salt is typically about 0.1 wt % or more, often about 0.1 wt % to about 20 wt % of the powder, preferably about 0.3 wt % to about 20 wt %, more preferably about 0.3 wt % to about 15 wt %, even more preferably about 0.3 wt % to about 10 wt %. The powder comprising lithium oxide and a lithium salt is not air sensitive, and without wishing to be bound by theory, it is believed that the lithium salt forms a coating on particles of lithium oxide, possibly in a core-shell structure.

The weight percents for the lithium salt and lithium oxide are determined by x-ray powder diffraction (XRD), with the understanding that there may be some amount of error in the XRD determinations because XRD detects only crystalline phases.

In the powder comprising lithium oxide and a lithium salt, the lithium salt is lithium bromide, lithium carbonate, lithium chloride, or lithium iodide; preferably the lithium salt is lithium carbonate.

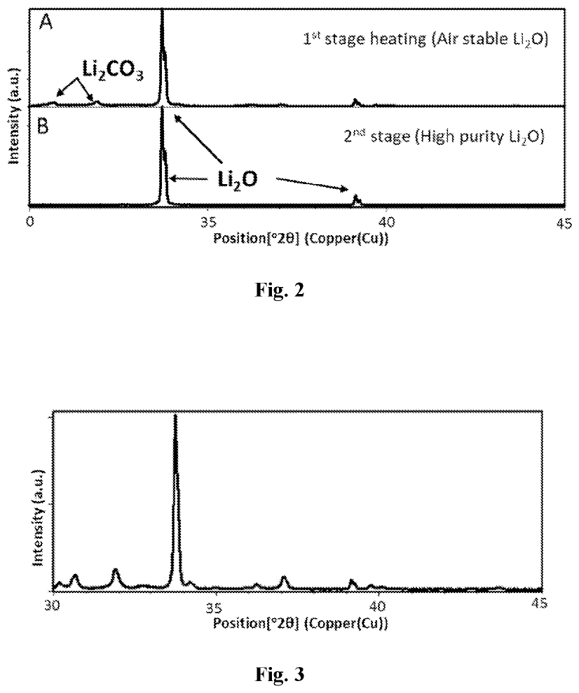

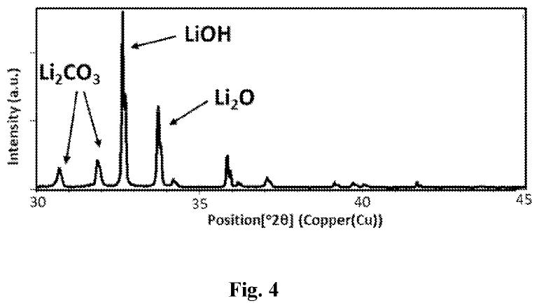

FIGS. 2A and 3 are x-ray powder diffraction (XRD) patterns for powders comprising lithium oxide and lithium carbonate formed according to the processes of the invention as described above. In each of these diffraction patterns, there is a large peak at a 20 value of 33.6 degrees, which is characteristic for Li₂O, and at most a very small peak at a 20 value of 32.5 degrees, which is characteristic for LiOH. FIG. 4 is an XRD pattern for a product formed in the absence of a non-reactive additive; the diffraction pattern has a noticeable peak at a 20 value of 33.6 degrees (Li₂O), and a much larger peak at a 20 value of 32.5 degrees (LiOH).

In the processes of the invention, the surfaces of the reaction vessel that are in contact with the reactants and products can be composed of any material that is corrosion resistant and is inert to the reactants and products (low-melting lithium salt, high-melting lithium salt, lithium oxide, optional non-reactive additive, and combinations thereof) and can withstand the temperatures of the process. The surfaces of the reaction vessel are usually composed of an inorganic oxide such as alumina or magnesia, or a metal such as nickel; alumina is often a preferred reaction vessel material. Other corrosion-resistant materials such as platinum or rhodium alloys can also be used as the reaction vessel material.

When a pure lithium oxide powder is desired, the powder comprising lithium oxide and a lithium salt is heated to a temperature in the range of about 25 degrees Celsius below the melting point of the lithium salt to about 200 degrees Celsius above the melting point of the lithium salt to form a lithium oxide powder when the lithium salt is lithium carbonate.

When a pure lithium oxide powder is desired, and the lithium salt is a lithium halide, the powder comprising lithium oxide and a lithium salt is heated to a temperature in the range of about 25 degrees Celsius below the boiling point of the lithium salt to about 200 degrees Celsius above the boiling point of the lithium salt to form a lithium oxide powder. The lithium halide can be lithium chloride, lithium bromide, or lithium iodide.

When a non-reactive additive is used in the process to form the powder comprising lithium oxide and a lithium salt, and the non-reactive additive is not lithium oxide, the non-reactive additive is preferably removed from the powder comprising lithium oxide and the lithium salt before heating the powder comprising lithium oxide and a lithium salt to the desired temperature to effect conversion of the lithium salt to lithium oxide.

For the processes for preparing a pure lithium oxide powder from a powder comprising lithium oxide and a lithium salt, the amount of lithium salt present in the powder comprising lithium oxide and a lithium salt is usually about 10 wt % or less, often about 5 wt % or less, and frequently about 3 wt % or less; typically, the amount of lithium salt in the powder comprising lithium oxide and a lithium salt is about 0.1 wt % or more. In some embodiments, the amount of lithium salt present in the powder comprising lithium oxide and a lithium salt is in the range of about 0.1 wt % to about 10 wt %, or about 0.1 wt % to about 5 wt %, or about 0.1 wt % to about 3 wt %.

Heating of the powder comprising lithium oxide and a lithium salt normally converts the lithium salt to lithium oxide.

Heating of the powder comprising lithium oxide and lithium carbonate to the desired reaction temperature is often at a rate of about 3° C./min. to about 100° C./min., preferably at a rate of about 5° C./min. to about 50° C./min., more preferably at a rate of about 8° C./min. to about 50° C./min.

When the desired temperature is reached, the powder comprising lithium oxide and a lithium salt can be heated at that temperature for the length of time necessary to form lithium oxide from the lithium salt. The temperature can be varied during the process. The time is affected to some extent by the reaction temperature, the temperature profile of the combination of the two lithium salts and the nonreactive additive, the reaction zone, and the amount of lithium salt present. On the laboratory scale, reaction times are in the range of about 5 minutes to about 25 hours.

The temperature for the process of heating of the powder comprising lithium oxide and a lithium salt is in the range of about 25 degrees Celsius below the melting point of the lithium salt to about 200 degrees Celsius above the melting point of the lithium salt, preferably about 25 degrees Celsius below the melting point of the lithium salt to about 175 degrees Celsius above the melting point of the lithium salt, more preferably about 25 degrees Celsius below the melting point of the lithium salt to about 100 degrees Celsius above the melting point of the lithium salt, when the lithium salt is lithium carbonate. While temperatures greater than about 200 degrees Celsius above the melting point of the lithium salt can be used, they do not provide any particular advantage. When the lithium salt is lithium carbonate, the temperature is preferably in the range of about 700° C. to about 900° C., more preferably in the range of about 700° C. to about 800° C., even more preferably in the range of about 700° C. to about 750° C. In some preferred embodiments in which the lithium salt is lithium carbonate, the temperature is preferably in the range of about 700° C. to about 750° C.

In the processes for forming pure lithium oxide from a powder comprising lithium oxide and a lithium salt, water is excluded by heating at reduced pressure, or in the presence of an inert gas or an oxygen-containing inert gas, preferably a flowing inert gas or oxygen-containing inert gas. The inert gas and the oxygen-containing inert gas are as described above for the process of heating of two lithium salts.

Preferably, the process of forming pure lithium oxide from a powder comprising lithium oxide and a lithium salt is conducted in the presence of a flow of inert gas or an oxygen-containing inert gas, which removes gaseous byproducts from the reaction zone. Flow rates for the inert gas or oxygen-containing inert gas are preferably about 25 sccm or more, or in the range of about 25 sccm to about 1000 sccm, more preferably about 50 sccm to about 500 sccm.

When conducting the process under reduced pressure, the pressure is preferably about 608 torr (81 kPa) or less, more preferably about 380 torr (51 kPa) or less, still more preferably about 230 torr (31 kPa) or less, even more preferably about 20 torr (2.7 kPa) or less. Optionally, an inert gas or oxygen-containing inert gas can be fed to the reaction zone while maintaining a reduced pressure.

The product from heating the powder comprising lithium oxide and a lithium salt is a lithium oxide powder that contains little or no lithium salt; the lithium oxide is air-sensitive, and usually is a free-flowing powder.

FIG. 2B is an XRD pattern for a product formed according to the processes of the invention. In the diffraction pattern, there is a large peak at a 20 value of 34 degrees (Li₂O); no peaks for lithium carbonate were observed.

The following examples are presented for purposes of illustration, and are not intended to impose limitations on the scope of this invention.

Some of the inventive Examples had incomplete conversion of the lower-melting lithium salt to lithium oxide. Higher conversion to lithium oxide may be achieved in these instances by heating for longer periods of time and/or using a higher inert gas flow rate.

### EXAMPLE 1

Lithium hydroxide monohydrate (LiOH·H₂O; 85 wt %) was combined with Li₂CO₃ (5 wt %) and Li₂O (10 wt %) in an acoustic mixer. After mixing for several minutes at ambient temperature, the mixture transferred to an alumina crucible and heated to 410° C. at a rate of 10° C./min. and held at 410° C. for 10 hours under argon flowing at 60 sccm. When the temperature reached 100° C., heat loss and weight loss were observed. Additional weight loss was observed during the 10 hours of heating at 410° C. The mixture was cooled to ambient temperature under a flow of argon to yield a free-flowing powder (FIG. 1A). An x-ray powder diffraction pattern was collected on a sample of the cooled product. The diffraction pattern obtained is shown in FIG. 2A. In the diffraction pattern, a large peak at a 2θ value of 33.6 degrees, which is characteristic for Li₂O, was observed. The small peaks at 2θ values of 12 degrees and 22 degrees were attributed to small amounts of Li₂CO₃ or LiOH in the product (the LiOH is from reaction of lithium oxide with water vapor).

The product powder from the above step was heated in an alumina crucible to 700° C. at a rate of 10° C./min. and held at 700° C. for 5 hours under argon flowing at 60 sccm. Weight loss was observed during the 5 hours of heating at 700° C. The mixture was cooled to ambient temperature under argon to yield a free-flowing powder. An x-ray powder diffraction pattern was collected on a sample of the cooled product. The diffraction pattern obtained is shown in FIG. 2B. In the diffraction pattern, a large peak at a 20 value of 34 degrees, which is characteristic for Li₂O, was observed, along with a smaller set of peaks at 38 degrees, which are also attributable to Li₂O. No peaks for Li₂CO₃ were observed.

### EXAMPLE 2

Lithium hydroxide monohydrate was exposed to air for 3 hours at room temperature to form a coating of Li₂CO₃ on the LiOH·H₂O (˜10 wt % Li₂CO₃). The coated LiOH·H₂O was combined with Li₂O (10 wt %) in an acoustic mixer. After mixing for several minutes at ambient temperature, the mixture transferred to an alumina crucible and heated to 410° C. at a rate of 10° C./min. and held at 410° C. for 15 hours under argon flowing at 60 sccm. The mixture was cooled to ambient temperature under a flow of argon to yield a free-flowing powder. An x-ray powder diffraction pattern was collected on a sample of the cooled product. The diffraction pattern obtained is shown in FIG. 3. In the diffraction pattern, a large peak at a 2θ value of 33 degrees (Li₂O) was observed, along with small peaks at 2θ values of 30.7 degrees and 31.7 degrees, which were attributed to small amounts of Li₂CO₃ in the product.

### EXAMPLE 3

Lithium hydroxide monohydrate was combined with Li₂CO₃ (10 wt %). This mixture was heated in an alumina crucible to 410° C. at a rate of 10° C./min. and held at 410° C. for 5 hours under argon flowing at 60 sccm. The mixture was cooled to ambient temperature under a flow of argon to yield a powder. An x-ray powder diffraction pattern was collected on a sample of the cooled product. The diffraction pattern obtained is shown in FIG. 4. In the diffraction pattern, a large peak at a 2θ value of 32.5 degrees (LiOH) was observed, along with a medium-sized peak at 33.6 degrees (Li₂O), and small peaks at 2θ values of 30.5 degrees and 31.7 degrees, which were attributed to small amounts of Li₂CO₃ in the product. Due to the relative sizes of the LiOH and Li₂O peaks, it was concluded that the LiOH had only partially converted to Li₂O. An image of the product, an agglomerated powder, is shown in FIG. 1B.

### EXAMPLE 4—COMPARATIVE

Lithium hydroxide monohydrate powder was heated in an alumina crucible to 480° C. at a rate of 10° C./min. and held at 480° C. for 5 hours under argon flowing at 60 sccm. Conversion of LiOH to Li₂O was complete after one hour. The product was cooled to ambient temperature under a flow of argon. The product was not a free-flowing powder. At ambient temperature, the product coated the walls of the alumina crucible. An image of the product is shown in FIG. 1C; the solid is not a powder, and extensive melting occurred during the process.

### EXAMPLE 5

Lithium hydroxide monohydrate (LiOH·H₂O; 85 wt %) was combined with Li₂CO₃ (5 wt %) and Li₂O (10 wt %) in an acoustic mixer. After mixing for several minutes at ambient temperature, the mixture transferred to an alumina crucible and heated to 410° C. at a rate of 10° C./min. and held at 410° C. for 10 hours under argon flowing at 60 sccm. When the temperature reached 100° C., heat loss and weight loss were observed. Additional weight loss was observed during the 10 hours of heating at 410° C. The mixture was cooled to ambient temperature under a flow of argon to yield a free-flowing powder. An x-ray powder diffraction pattern was collected on a sample of the cooled product. In the diffraction pattern, a large peak at a 2θ value of 33.6 degrees, which is characteristic for Li₂O, was observed. The small peaks at 2θ values of 12 degrees and 22 degrees were attributed to small amounts of Li₂CO₃ or LiOH in the product (the LiOH is from reaction of lithium oxide with water vapor).

The product powder from the above step was heated in an alumina crucible to 700° C. at a rate of 10° C./min. and held at 700° C. for 5 hours under argon flowing at 60 sccm. Weight loss was observed during the 5 hours of heating at 700° C. The mixture was cooled to ambient temperature under argon to yield a free-flowing powder. An x-ray powder diffraction pattern was collected on a sample of the cooled product. In the diffraction pattern, a large peak at a 2θ value of 34 degrees, which is characteristic for Li₂O, was observed, along with a smaller set of peaks at 38 degrees, which are also attributable to Li₂O. No peaks for Li₂CO₃ were observed.

### EXAMPLE 6

Two runs were performed in which lithium hydroxide monohydrate (LiOH·H₂O; 90 wt %) was combined with Li₂CO₃ and Li₂O (˜10 wt %) in an acoustic mixer. In one run, 0.3 wt % lithium carbonate was added; in the other run, 0.5 wt % lithium carbonate was added, for total amounts of 0.4 wt % lithium carbonate and 0.6 wt % lithium carbonate. After mixing for several minutes at ambient temperature, each mixture transferred to an alumina crucible and heated to 410° C. at a rate of 10° C./min. and held at 410° C. for 10 hours under argon flowing at 60 sccm. When the temperature reached 100° C., heat loss and weight loss were observed. Additional weight loss was observed during the 10 hours of heating at 410° C. The mixture was cooled to ambient temperature under a flow of argon to yield a free-flowing powder.

### EXAMPLE 7

Three runs were performed in which lithium hydroxide monohydrate (LiOH·H₂O; 90 wt %) was combined with Li₂CO₃ and Li₂O in an acoustic mixer and heated at 410° C. as described in Example 6. Run 1 had 0.1 wt % lithium carbonate, 10 wt % lithium oxide, and the LiOH was unmilled, with a 600 μm average particle size. Runs 2 and 3 had 0.7 wt % lithium carbonate (0.6 wt % lithium carbonate added) and 10 wt % lithium oxide. In Run 2, the LiOH was unmilled, with a 600 μm average particle size. In Run 3, the LiOH was milled to an average particle size of 10 μm. Runs 2 and 3 were held at 410° C. for 20 hours.

The products of Runs 2 and 3 were heated in alumina crucibles to 800° C. at a rate of 10° C./min. and held at 800° C. for 30 minutes under argon flowing at 60 sccm. The products were cooled to ambient temperature under argon to yield free-flowing powders.

### EXAMPLE 8

A run was performed in which unmilled lithium hydroxide monohydrate (LiOH·H₂O; 90 wt %) was combined with 0.2 wt % Li₂CO₃ and 10 wt % Li₂O in an acoustic mixer and heated as described in Example 6, except that the temperature was held at 418° C. for 10 hours, then at 430° C. for 5 hours, then at 440° C. for 5 hours, and then at 450° C. for 5 hours. An x-ray powder diffraction pattern was collected on a sample of the cooled product. The diffraction pattern showed that about 1.1 wt % LiOH remained in the product, indicating that stepwise heating provides a higher conversion rate to lithium oxide, at least for conversion from lithium hydroxide.

### EXAMPLE 9

Two runs were performed in which lithium hydroxide monohydrate (LiOH·H₂O; 20 wt %) was combined with 2.65 wt % Li₂CO₃ and 80 wt % Li₂O in an acoustic mixer and heated as described in Example 6, except that the temperature was 450° C., the time was 10 hours, and the crucible was Pt/Rh/alumina. In one run, the LiOH was unmilled, and the other run, the LiOH had been ball milled for 20 minutes prior to combination with the other ingredients.

The powder obtained from the run using the ball milled LiOH was partly agglomerated. An x-ray powder diffraction pattern was collected on a sample of the cooled product from the unmilled LiOH run; the diffraction pattern showed peaks from LiOH·H₂O, indicating incomplete conversion. to Li₂O. An x-ray powder diffraction pattern was collected on a sample of the cooled product from the milled LiOH run; the diffraction pattern showed peaks from LiOH·H₂O, indicating either contamination from air exposure or incomplete conversion to Li₂O.

### EXAMPLE 10

Lithium hydroxide monohydrate (LiOH·H₂O, 20 g) containing Li₂CO₃ (0.3 wt %) in an alumina crucible was placed in a vertical furnace set at a temperature of 450° C. (actual temperature about 425° C.) and for 3 hours under argon flowing at 5 L/min (5000 sccm). The mixture was cooled to ambient temperature under a flow of argon to yield a free-flowing powder. An x-ray powder diffraction pattern was collected on a sample of the cooled product. The diffraction pattern obtained indicated that the product contained 23 wt % Li₂O and 77 wt % LiOH.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A process for producing a powder comprising lithium oxide and a lithium salt, which process comprises heating a mixture of two lithium salts at one or more temperatures ranging from about 50 degrees Celsius below the eutectic point of the mixture of two lithium salts to a temperature below the melting point of the lithium salt having a lower melting point while removing at least a portion of gaseous byproducts produced by the process, and optionally wherein a non-reactive additive is present in the mixture of two lithium salts, to form a powder comprising lithium oxide and a lithium salt.

2. A process as in claim 1 wherein the heating is at one or more temperatures ranging from about 20 degrees Celsius below the eutectic point of the mixture of two lithium salts to a temperature below the melting point of the lithium salt having a lower melting point.

3. A process as in claim 1 wherein the two lithium salts are selected from lithium nitrate and lithium bromide; lithium hydroxide and lithium bromide; lithium bromide and lithium carbonate; lithium hydroxide and lithium carbonate; lithium bromide and lithium chloride; and lithium nitrate and lithium iodide.

4. A process as in claim 1 wherein the two lithium salts are
lithium nitrate and lithium bromide, and the temperature is in the range of about 178° C. to below about 255° C.;
lithium hydroxide and lithium bromide, and the temperature is in the range of about 225° C. to below about 470° C.;
lithium bromide and lithium carbonate, and the temperature is in the range of about 446° C. to below about 550° C.; or
lithium hydroxide and lithium carbonate, and the temperature is in the range of about 380° C. to below about 470° C.; or
lithium bromide and lithium chloride, and the temperature is in the range of about 471° C. to below about 550° C.

5. A process as in claim 4 wherein the two lithium salts are lithium hydroxide and lithium carbonate.

6. A process as in claim 2 wherein the two lithium salts are lithium hydroxide and lithium carbonate, and wherein the lithium carbonate is formed in situ in the presence of the lithium hydroxide.

7. A process as in claim 5 wherein lithium carbonate is in an amount of about 0.1 wt % to about 20 wt % relative to the total weight of the mixture.

8. A process as in claim 5 wherein the temperature is in the range of about 380° C. to about 460° C.

9. A process as in claim 2 wherein the lithium hydroxide is anhydrous lithium hydroxide.

10. A process as in claim 2 wherein the lithium hydroxide is lithium hydroxide monohydrate.

11. A process as in claim 1 wherein a non-reactive additive is present, and is selected from quartz, silica beads, zirconia beads, and lithium oxide.

12. A process as in claim 1 wherein a non-reactive additive is present, and is lithium oxide.

13. A process as in claim 1 wherein a non-reactive additive is present in an amount of about 1 wt % to about 90 wt % relative to the total weight of the mixture.

14. A process as in claim 1 wherein a non-reactive additive is present in an amount of about 20 wt % to about 90 wt % relative to the total weight of the mixture.

15. A process as in claim 1 wherein the process is conducted in the presence of an inert gas or an oxygen-containing inert gas flowing at a rate of about 25 sccm or more.

16. A process as claim 15 wherein the inert gas is one or more of helium, nitrogen, and argon.

17. A process as in claim 1 wherein the process is conducted at subatmospheric pressure.

18. A process as in claim 1 wherein the process is conducted at pressure of about 81 kPa or less.

19. A process as in claim 1 which further comprises heating the powder comprising lithium oxide and lithium carbonate to a temperature in the range of about 25 degrees Celsius below the melting point of lithium carbonate to about 200 degrees Celsius above the melting point of lithium carbonate, to form a lithium oxide powder.

20. A process which comprises heating a powder comprising lithium oxide and lithium carbonate at one or more temperatures in the range of about 25 degrees Celsius below the melting point of lithium carbonate to a temperature about 200 degrees Celsius above the melting point of lithium carbonate, to form a lithium oxide powder.

21. A process as in claim 19 wherein the temperature is in the range of about 700° C. to about 900° C.

22. A process which comprises heating a powder comprising lithium oxide and a lithium halide at one or more temperatures in the range of about 25 degrees Celsius below the boiling point of the lithium halide to a temperature about 200 degrees Celsius above the boiling point of the lithium halide, to form a lithium oxide powder.

23. A powder comprising lithium oxide and a lithium salt wherein the lithium salt is about 0.1 wt % or more of the powder.

24. A powder as in claim 23 comprising lithium oxide and lithium carbonate wherein the lithium carbonate is about 0.3 wt % or more of the powder.

25. A powder as in claim 24 wherein the lithium carbonate is about 0.3 wt % to about 20 wt % of the powder.
